(19) United States
(12) Patent Application Publication
(10) Pub. No.: US 2003/0122828 A1
(43) Pub. Date: Jul. 3, 2003

(54) Projection of three-dimensional images

(75) Inventor: Andrew A. Lukyanitsa, Moscow (RU)

Correspondence Address: HOGAN & HARTSON LLP, IP GROUP, COLUMBIA SQUARE, 555 THIRTEENTH STREET, N.W., WASHINGTON, DC, 20004, US

(73) Assignee: NeurOK, LLC, Arlington, VA

(21) Appl. No.: 10/279,010

(22) Filed: Oct. 24, 2002

Related U.S. Application Data
(60) Provisional application No. 60/335,557, filed on Oct. 24, 2001.

(51) Int. Cl. G06T 11/20

(52) U.S. Cl. 345/440

(57) ABSTRACT

Disclosed herein are three-dimensional projection systems and related methods employing liquid crystal display panels and a phase screen to project a true three-dimensional image of an object. Certain embodiments of the projection systems can include an imaging system capable of projecting “amplitude hologram” images onto a phase screen to produce a viewable three-dimensional image. The imaging systems disclosed use at least one liquid crystal display panel, an image generation system for calculating flat image information and for controlling the liquid crystal panels, and a phase screen. The screen has regular “phase” information recorded on it, which can be a known phase-only or phase-plus-amplitude hologram that is not dependent on three-dimensional object to be projected. In preferred embodiments of the present invention, the projection system uses an image generation system that employs a neural network feedback calculation to calculate the appropriate flat image information and appropriate images to be displayed on the liquid crystal displays at any given time.

### REFERENCE TO RELATED APPLICATIONS

This application claims the benefit of the filing date of U.S. provisional patent application Serial No. 60/335,557, filed Oct. 24, 2001.

### FIELD OF THE INVENTION

The present invention relates to the projection of three-dimensional images. More particularly, the present invention relates to apparatuses and related methods for three dimensional image projection utilizing parallel information processing of stereo aspect images.

### BACKGROUND OF THE INVENTION

Projective displays use images focused onto a diffuser to present an image to a user. The projection may be done from the same side of the diffuser as the user, as in the case of cinema projectors, or from the opposite side. The image is typically generated on one or more “displays,” such as a miniature liquid crystal display device that reflects or transmits light in a pattern formed by its constituent switchable pixels. Such liquid crystal displays are generally fabricated with microelectronics processing techniques such that each grid region, or “pixel,” in the display is a region whose reflective or transmissive properties can be controlled by an electrical signal. In an liquid crystal display, light incident on a particular pixel is either reflected, partially reflected, or blocked by the pixel, depending on the signal applied to that pixel. In some cases, liquid crystal displays are transmissive devices where the transmission through any pixel can be varied in steps (gray levels) over a range extending from a state where light is substantially blocked to the state in which incident light is substantially transmitted.

When a uniform beam of light is reflected from (or transmitted through) a liquid crystal display, the beam gains a spatial intensity profile that depends on the transmission state of the pixels. An image is formed at the liquid crystal display by electronically adjusting the transmission (or gray level) of the pixels to correspond to a desired image. This image can be imaged onto a diffusing screen for direct viewing or alternatively it can be imaged onto some intermediate image surface from which it can be magnified by an eyepiece to give a virtual image.

The three-dimensional display of images, which has long been the goal of electronic imaging systems, has many potential applications in modern society. For example, training of professionals, from pilots to physicians, now frequently relies upon the visualization of three-dimensional images. Further it is important that multiple aspects of an image be able to be viewed so that, for example, during simulations of examination of human or mechanical parts, a viewer can have a continuous three-dimensional view of those parts from multiple angles and viewpoints without having to change data or switch images.

Thus, real-time, three-dimensional image displays have long been of interest in a variety of technical applications. Heretofore, several techniques have been known in the prior art to be used to produce three-dimensional and/or volumetric images. These techniques vary in terms of complexity and quality of results, and include computer graphics which simulate three-dimensional images on a two-dimensional display by appealing only to psychological depth cues; stereoscopic displays which are designed to make the viewer mentally fuse two retinal images (one each for the left and right eyes) into one image giving the perception of depth; holographic images which reconstruct the actual wavefront structure reflected from an object; and volumetric displays which create three-dimensional images having real physical height, depth, and width by activating actual light sources of various depths within the volume of the display.

Basically, three-dimensional imaging techniques can be divided into two categories: those that create a true three-dimensional image; and those that create an illusion of seeing a three-dimensional image. The first category includes holographic displays, varifocal synthesis, spinning screens and light emitting diode (“LED”) panels. The second category includes both computer graphics, which appeal to psychological depth cues, and stereoscopic imaging based on the mental fusing of two (left and right) retinal images. Stereoscopic imaging displays can be sub-divided into systems that require the use of special glasses, (e.g., head mounted displays and polarized filter glasses) and systems based on auto-stereoscopic technology that do not require the use of special glasses.

Recently, the auto-stereoscopic technique has been widely reported to be the most acceptable for real-time full-color three-dimensional displays. The principle of stereoscopy is based upon the simultaneous imaging of two different viewpoints, corresponding to the left and right eyes of a viewer, to produce a perception of depth to two-dimensional images. In stereoscopic imaging, an image is recorded using conventional photography of the object from different vantages that correspond, for example, to the distance between the eyes of the viewer.

Ordinarily, for the viewer to receive a spatial impression from viewing stereoscopic images of an object projected onto a screen, it has to be ensured that the left eye sees only the left image and the right eye only the right image. While this can be achieved with headgear or eyeglasses, auto-stereoscopic techniques have been developed in an attempt to abolish this limitation. Conventionally, however, auto-stereoscopy systems have typically required that the viewer's eyes be located at a particular position and distance from a view screen (commonly known as a “viewing zone”) to produce the stereoscopic effect.

One way of increasing the effective viewing zone for an auto-stereoscopic display is to create multiple simultaneous viewing zones. This approach, however, imposes increasingly large bandwidth requirements on image processing equipment. Furthermore, much research has been focused on eliminating the restriction of viewing zones by tracking the eye/viewer positions in relation to the screen and electronically adjusting the emission characteristic of the imaging apparatus to maintain a stereo image. Thus, using fast, modern computers and motion sensors that continuously register the viewer's body and head movements as well as a corresponding image adaptation in the computer, a spatial impression of the environment and the objects (virtual reality) can be generated using stereoscopic projection. As the images become more complex, this prior art embodying this approach has proven less and less useful.

Because of the nature of stereoscopic vision, it is difficult for this technique to satisfy the perception of viewers with respect to one basic requirement of true volume visualization: physical depth cues. No focal accommodation, convergence, or binocular disparity can be provided in auto-stereoscopy, and parallax can be observed only from discrete positions in limited viewing zones in prior art auto-stereoscopy systems.

Furthermore, regardless of the device realization, stereoscopic displays suffer from a number of inherent problems. The primary problem is that any stereoscopic pair gives the correct perspective when viewed from one position only. Thus, auto-stereoscopic display systems must be able to sense the position of the observer and regenerate the stereo-paired images with different perspectives as the observer moves. This is a difficult task that has not be mastered in the prior art. Furthermore, misjudgments of distance, velocity and shape by a viewer of even high-resolution stereoscopic images occur because of the lack of physical cues. Inherently, stereoscopic systems give depth cues that conflict with convergence and physical cues because the former use fixed focal accommodation, and, thus disagree with the stereoscopic depth information provided by the latter. This mismatch causes visual confusion and fatigue, and is part of the reason for the headaches that many people develop when watching stereoscopic three-dimensional images.

Nevertheless, recent work in the field of electronic display systems has concentrated on the development of various stereoscopic viewing systems as they appear to be the most easily adapted to electronic three-dimensional imaging. Holographic imaging technologies, while being superior to traditional stereoscopic-based technologies in that a true three-dimensional image is provided by recreating the actual wavefront of light reflecting off a the three-dimensional object, are more complex than other three-dimensional imaging technologies. The basic prior art of holographic image recording and recreation is depicted in FIG. 1a, FIG. 1b and FIG. 1c. One generally accepted method for producing a hologram is illustrated in FIG. 1a. A beam of coherent light is split into two beams by a beam splitter source 103. The first beam 105 goes towards the object 102, while the second beam 104 (commonly referred to as the “main” beam) goes directly to the registering media 101. The first beam 105 reflects from the object 102 and then adds and interferes with the second (main) beam 104 at the registering media 101 (a holographic plate or film). The superposition of these two beams is thereby recorded in registering media as a hologram. FIG. 1b shows the presence of the recorded hologram 100 on the registering media 101.

Once a hologram 100 is recorded in the manner according to FIG. 1a, it can be used to recreate a holographic image 110 of the object. If another second “main” beam 104 is sent to the recorded hologram, as illustrated in FIG. 1b, then a light wave front will be formed at predefined angle in hologram's surface. This light wave front will correspond to a three-dimensional object's holographic image 104. Conversely, if coherent light such as first beam 105 is sent to the original three-dimensional object 102, and then reflected to the hologram 100 as reflected beam 106, as illustrated in FIG. 1c, then the hologram reflects a light beam 104′ back to the image source (corresponding to the “main” beam of FIG. 1a). This is the principle commonly employed used by optical correlators. Holographic imaging technology, however, has not been fully adapted to real-time electronic three-dimensional displays.

What would be desirable is a system that provides numerous aspects or “multi-aspect” display such that the user can see many aspects and views of a particular object when desired. It would further be useful for such viewing to take place in a flexible way so that the viewer is not constrained in terms of the location of the viewer's head when seeing the stereo image. Finally, it would be desirable for such a system to be able to provide superior three-dimensional image quality while being operable without the need for special headgear.

Thus, there remains a need in the art for improved methods and apparatuses that enable the projection of high-quality three-dimensional images to multiple viewing locations without the need for specialized headgear.

### SUMMARY OF THE INVENTION

In view of the foregoing and other unmet needs, it is an object of the present invention to provide a three-dimensional image system that enables projection of multiple aspects and views of a particular object.

Similarly, it is an object of the present invention to provide apparatuses and associated methods for multi-aspect three-dimensional imaging that provides high resolution images without having to limit the viewer to restricted viewing zones. It is further an object of the present invention that such apparatuses and the associated methods do not require the viewer to utilize specialized viewing equipment, such as headgear or eyeglasses.

Also, it is an object of the present invention to provide true three-dimensional displays and related imaging methods that can display holographic images using electronically generated and controlled images.

Further, it is an object of the present invention to provide three-dimensional displays and related imaging methods that can display holographic images using images which have been calculated to produce a three-dimensional image when paired with a phase screen.

To achieve these and other objects, three-dimensional projection systems and related methods according to the invention employ a liquid crystal display panel, or a plurality thereof, and a screen upon which is projected an amplitude holographic display of an object. Embodiments of projection systems according to the present invention comprise an imaging system capable of numerically calculating image information and using that information to control the characteristics of the liquid crystal display. The calculated image information relates to a desired three-dimensional image scene. The calculated image information causes the liquid crystal display to be controlled in such a manner that an image is produced thereon, and light passes through the display and hits the screen where it interacts with phase information on the screen to produce a viewable three-dimensional image. The imaging system comprises one or more liquid crystal display panels, an image generation system for performing calculations regarding three-dimensional image generation and for controlling the liquid crystal panels, and a screen. In such embodiments, the screen has regular “phase” information recorded on it, which can be a phase-only or mixed phase-amplitude hologram that is not dependent on a three-dimensional object to be projected.

In preferred embodiments of the present invention, a system and method for presentation of multiple aspects of an image to create a three dimensional viewing experience utilizes at least two liquid crystal panels, an image generation system for controlling the liquid crystal display panels, and a phase screen to generate a three dimensional viewable image. The image generation system in such preferred embodiments is an auto-stereoscopic image generation system that employs a neural network feedback calculation to calculate the appropriate stereoscopic image pairs to be displayed at any given time.

According to certain embodiments of the present invention, separate sets of liquid crystal panels can be used for each color such that full color displays can be obtained. In one such embodiment, individual liquid crystal panels can be provided for each of red light, blue light, and green light. In one embodiment, the projection system is a tri-chromatic color-sequential projection system. In this embodiment, the projection system has three light sources for three different colors, such as red, green, and blue, for example. The image display sequentially displays red, green, and blue components of an image. The liquid crystal display and the light sources are sequentially switched so that when a red image is displayed, the corresponding liquid crystal display is illuminated with light from the red source. When the green portion of the image is displayed by the appropriate liquid crystal display, that display is illuminated with light from the green source, etc.

Various preferred aspects and embodiments of the invention will now be described in detail with reference to figures.

### BRIEF DESCRIPTION OF THE DRAWINGS

FIG. 1a, FIG. 1b and FIG. 1c are illustrations of one method employed in the prior art to produce a hologram and of the properties of such a hologram.

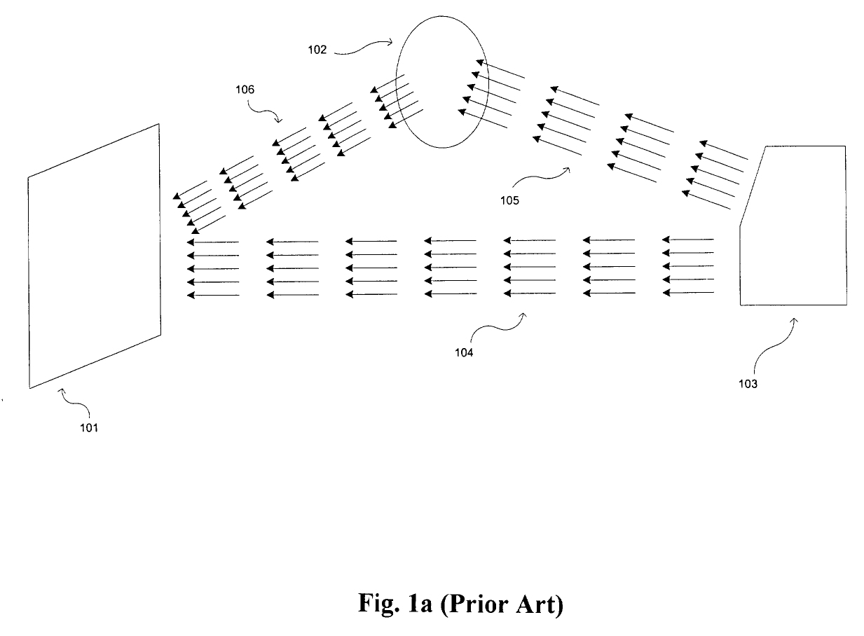

FIG. 2 is a schematic diagram depicting the production of a holographic image by a projection system according to embodiments of the present invention.

FIG. 3 is a schematic diagram depicting a projection system according to embodiments of the present invention.

FIG. 4 is a schematic diagram depicting the computational and control architecture of an imaging processing unit as utilized in embodiments of the present invention.

FIG. 5 is a schematic diagram illustrating the stereoscopic direction of light rays achieved according to embodiments of the present invention.

FIG. 6 is a flow diagram depicting a process whereby the display of appropriate stereoscopic images is automatically controlled according to embodiments of the present invention.

FIG. 7 is a schematic diagram illustrating a suitable neural network that can be used to control the display of multi-aspect image data according to embodiments of the present invention.

### DETAILED DESCRIPTION OF THE PREFERRED EMBODIMENTS

The present invention in its preferred embodiment is a system and method for presentation of multiple aspects of an image to create a three dimensional viewing experience using at least two liquid crystal panels, an image generation system for controlling the liquid crystal panels, and a phase screen.

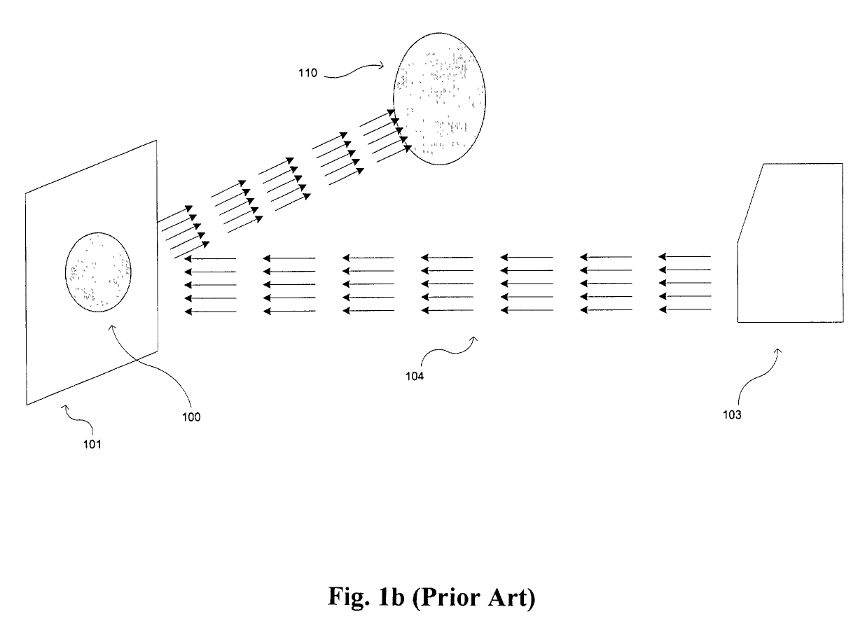

The present invention, as illustrated in FIG. 2, uses a screen 112 with regular “phase” information F recorded on it. This can be a known phase-only or mixed phase-amplitude hologram that is not dependent on three-dimensional object to be projected. In particular, the present invention can use a “thick Denisyuk's” hologram, but is not limited thereto. For example, a screen can be fabricated of glass with special polymer layer having a complex surface in it created by laser.

To display the image 110′ a three-dimensional object 0 on the phase screen, the first step is to calculate at least one “flat” (i.e., two-dimensional) image, taking into account the features of the “phase” screen and the desired three-dimensional object to be imaged. This calculation process is described below with respect to the calculation of auto-stereoscopic image pairs. As will be readily understood by one of ordinary skill in the art, those calculations can be readily applied to calculate an image as will be needed in embodiments of the present invention. The above-mentioned flat images are, in essence, an amplitude hologram. Herein, the flat calculated images can be conceptually referred to as F+0, or F−0, where F denotes phase information for the desired image, and 0 denotes the full three-dimensional object image. These images are displayed on the liquid crystal display panel 113 and projected (in conjunction with light source 114 to produce beam 111) to the phase screen where the phase information F is separated out due to the interaction of the screen and the calculated image. The result is the creation of a true holographic wavefront 115 and thus a true three-dimensional image 110′ of object 0. Although this projection will typically be done with usual light, it is also possible to use coherent light sources: R, G, B. Because the screen has “phase” in it, the phase information acts as a light divider and only a three-dimensional image appears on the screen.

In the generally accepted methods of the prior art, a hologram is illuminated by light or by a three-dimensional object image. The present invention illuminates a “phase” surface by an “amplitude hologram.” In a typical case, the “phase” screen can be any kind of surface with regular functions in it, not only a “phase” hologram. Real three-dimensional images consist of a number of light waves with different phases and amplitudes. Conventional liquid crystal displays, however, are only able to recreate amplitude information. The present invention, therefore employs the use of a screen that is written out to contain known phase (or, alternatively, phase plus amplitude) information. As a result, this screen is able to add appropriate phase information into particular calculated amplitude-only image information (provided in the form of images created on an liquid crystal display panel an imaged on the screen) in order to reconstruct a real three-dimensional image light structure. Therefore, in the present description of the invention, the screen is referred to as a “phase” screen while the calculated two-dimensional images are referred to as “amplitude holograms.”

One significant advantage of the approach according to the present invention is the capability of projecting large three-dimensional images. Also, it is an economically practical method because it is more feasible to create a big screen with a regular “phase” structure than it is to create a large hologram.

Another advantage is that the “amplitude hologram” that appears in the liquid crystal display panels is calculated. When a typical hologram is recorded, each point must be distributed along the whole hologram. This process requires high quality recording materials and all objects on a scene of a hologram must be fixed. By using calculated images, the present invention can minimize superfluity and show a “hologram” in liquid crystal panels having lower resolution than that of photo materials.

In alternative embodiments of the invention, separate liquid crystal panels can be used for each primary color to produce multi-color displays.

With respect to the “phase” screen, in principle, a phase structure is just an arbitrary, pre-defined, regular function system. This function system must be full and orthogonal with the aim of decreasing redundancy. In particular, the present invention can use trigonometric functions such as sines and cosines, or Welsh functions (i.e., it can be non-trigonometric functions, too).

Image Calculations

Methods for calculating image information suitable for use in the present invention will now be described with respect to an example based upon the generation of image pairs for auto-stereoscopic imaging using at least two liquid crystal display panels. One of ordinary skill in the art will readily understand how this exemplary calculation method can be employed in embodiments of the present invention.

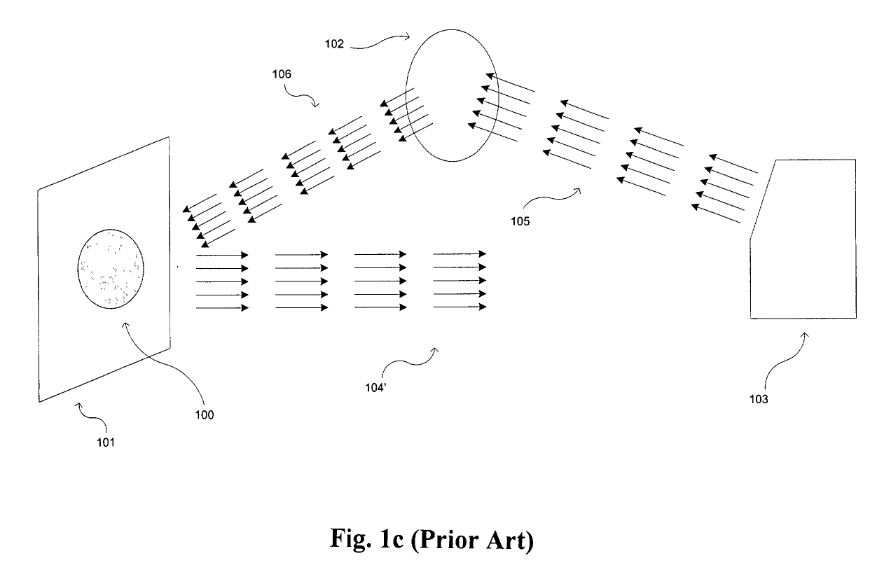

Referring now to FIG. 3, computational device 1 provides control for an illumination subsystem 2 and for the display of images on two discreet liquid crystal displays 4 and 6 separated by a spatial mask 5. Illumination source 2, which is controlled by the computational device 1, illuminates the transmissive liquid crystal displays 4 and 6 that are displaying images provided to them by the computational device 1.

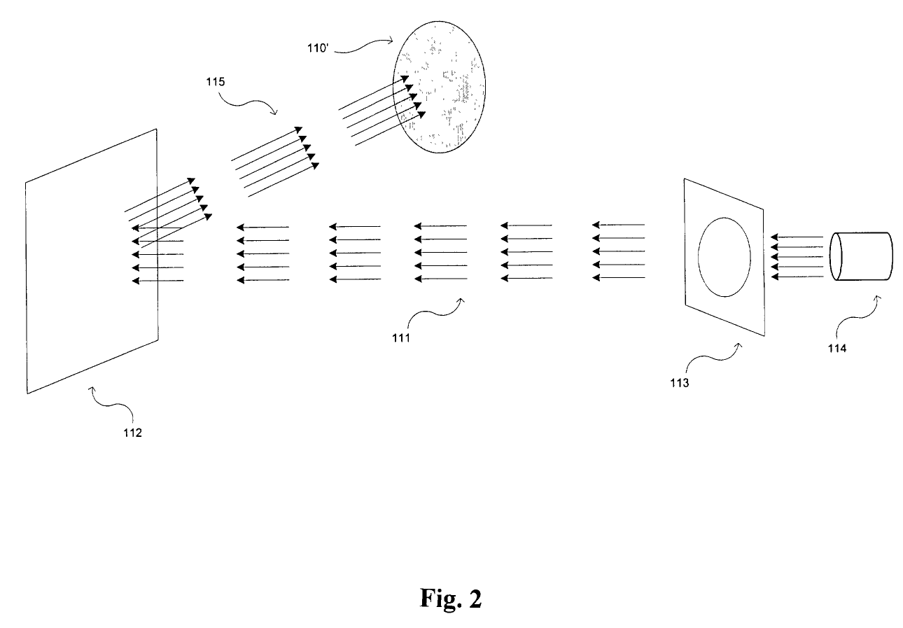

FIG. 4 illustrates the detail for the computational device 1. The invention comprises a database of stereopairs or aspects 8 which are provided to the memory unit 12. Memory unit 12 has several functions. Initially memory unit 12 will extract and store a particular stereopair from the stereopair database 8.

Memory unit 12 provides the desired stereopair to the processing block 14 to produce calculated images. The calculated images can be directly sent from processing block 14 to liquid crystal display panel and lighting unit control 16 or stored in memory unit 12 to be accessed by control unit 16. Unit 16 then provides the calculated images to the appropriate liquid crystal display panels 4, 6 as well as controls the lighting that illuminates the transmissive liquid crystal display panels 4, 6. Processing block 14 can also provide instructions to liquid crystal display and lighting control unit 16 to provide the appropriate illumination.

As is the case with all auto-stereoscopic displays, the images produced by the computing device 1 are necessarily a function of the viewer position, as indicated by the viewer position signal 10. Various methods are known in the art for producing a suitable viewer position signal. For example, U.S. Pat. No. 5,712,732 to Street describes an auto-stereoscopic image display system that automatically accounts for observer location and distance. The Street display system comprises a distance measuring apparatus allowing the system to determine the position of the viewer's head in terms of distance and position (left-right) relative to the screen. Similarly, U.S. Pat. No. 6,101,008 to Popovich teaches the utilization of digital imaging equipment to track the location of a viewer in real time and use that tracked location to modify the displayed image appropriately.

It should be noted that memory unit 12 holds the accumulated signals of individual cells or elements of the liquid crystal display. Thus the memory unit 12 and processing block 14 have the ability to accumulate and analyze the light that is traveling through relevant screen elements of the liquid crystal display panels toward the “phase” screen.

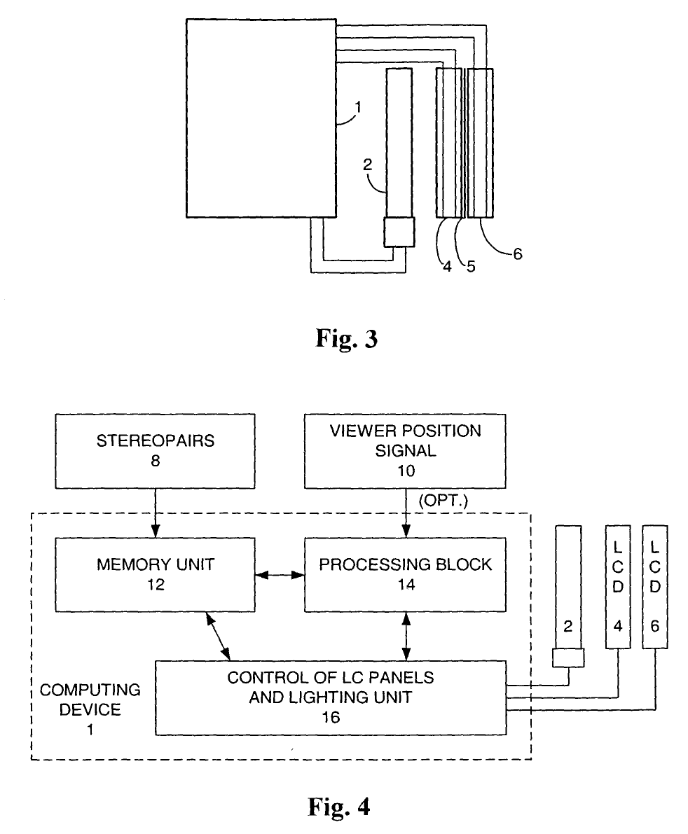

Referring to FIG. 5, a diagram of the light beam movement that can be created by the liquid crystal display panels according to the present invention. Although shown and described with respect to a pair of stacked liquid crystal display panels that will display stereoscopic left and right eye views, similar computations can be made for the projected “amplitude hologram” that reaches the phase screen. In this illustration, a three-panel liquid crystal display system is illustrated. In this instance the display comprises an image presented on a near panel 18, a mask panel 20 and a distant image panel 22. The relative position of these panels is known and input to the processing block for subsequent display of images. Although illustrated as an liquid crystal display panel that is capable of storing image information, mask panel 20 could also be a simpler spatial mask device, such as a diffuser.

Different portions of the information needed to present each stereopair to a viewer are displayed in each element of panels 18, 20, and 22 by sending appropriate calculated images to each panel. In this illustration, left eye 36 sees a portion 28 on panel 18 of the calculated image sent to that panel. Since the panels are transmissive in nature, left eye 36 also sees a portion 26 of the calculated image displayed on the mask liquid crystal display panel 20. Additionally, and again due to the transmissivity of each liquid crystal display panel, left eye 36 also sees a portion 24 of the calculated image which is displayed on a distant liquid crystal display panel 22. In this manner, desired portions of the calculated images are those that are seen by the left eye of the viewer.

The displays are generally monochromatic devices: each pixel is either “on” or “off” or set to an intermediate intensity level. The display typically cannot individually control the intensity of more than one color component of the image. To provide color control, a display system may use three independent pairs of liquid crystal displays. Each of the three liquid crystal display pairs is illuminated by a separate light source with spectral components that stimulate one of the three types of cones in the human eye. The three displays each reflect (or transmit) a beam of light that makes one color component of a color image. The three beams are then combined through prisms, a system of dichromic filters, and/or other optical elements into a single chromatic image beam.

Similarly, right eye 34 sees the same portion 28 of the calculated image on the near panel 18, as well as sees a portion 30 of the calculated image displayed on the mask panel 20, as well as a portion 32 of the calculated image on distant panel 22. These portions of the calculated images are those that are used to calculate the projected image resulting from the phase screen.

These portions of the calculated images seen by the right and left eye of the viewer constitute two views seen by the viewer, thereby creating a stereo image.

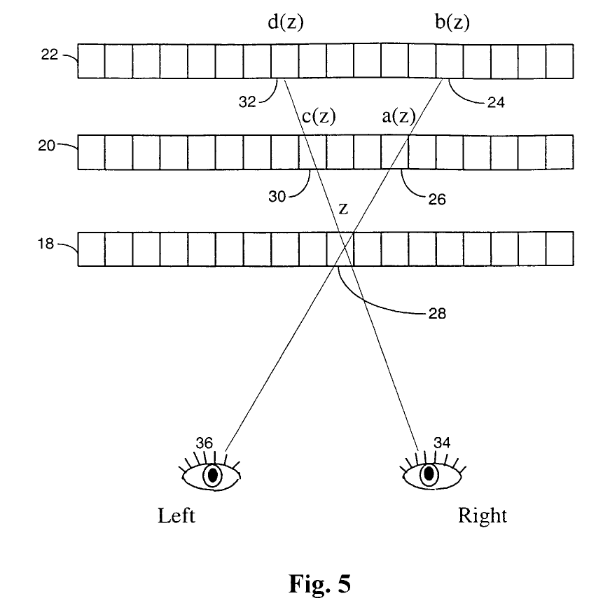

Referring to FIG. 6, the data flow for the manipulation of the images of the present invention is illustrated. As noted earlier the memory unit 12, processing block 14, and liquid crystal display control and luminous control 16 regulate the luminous radiation emanating from the distant screen 22 and the transmissivity of the mask 20 and near screen 18.

Information concerning multiple discreet two dimensional (2-D) images (i.e., multiple calculated images) of an object, each of which is depicted in multiple different areas on the liquid crystal display screens, and, optionally, information about positions of the right and left eyes of the viewer are adjusted by the processor block 14.

Signals corresponding to the transmission of a portion 28 of near screen 18, the transmissivity of mask 20 corresponding to the left and right eye respectively (26, 30) and the distant screen 22 corresponding to the luminous radiation of those portions of the image of the left and right eye respectively (24, 32) are input to the processing block following the set program.

The light signals from the cells of all screens that are directed toward the right and left eye of each viewer are then identified. In this example signals from cell 28, 26, and 24, are all directed toward the left eye of the viewer 36 and signals from block 28, 30, and 32 are directed the right eye of the viewer 34.

Each of these left and right eye signals is summed 38 to create a value for the right eye 42 and the left eye 40. These signals are then compared in a compare operation 48 to the relevant parts of the image of each aspect and to the relevant areas of the image of the object aspects 44 and 46.

Keeping in mind that the signal is of course a function of the location of the viewer's eyes, the detected signal can vary to some extent. Any errors from the comparison are identified for each cell of each near mask, and distant screen. Each error is then compared to the set threshold signal and, if the error signal exceeds the set threshold signal, the processing block control changes the signals corresponding to the luminous radiation of at least part of the distant screen 22 cells as well changes the transmissivity of at least part of the mask and near cells of the liquid crystal display displays.

If the information concerning the calculated images of the object changes, as a result of movement of the viewer position, the processing block senses that movement and inputs into the memory unit signals corresponding to luminous radiation of the distant screen cells as well as the transmissivity of the mask and near screen cells until the information is modified. When the viewer position varies far enough to require a new view, that view or image is extracted from the database and processed.

In a simple embodiment, the present invention consists of two transmissive liquid crystal display screens, such as illustrated in FIG. 3. The distant and nearest (hereinafter called near) screens 4 and 6 are separated by a gap in which a spatial mask 5 is placed. This mask may be pure phase (e.g., lenticular or random screen), amplitude or complex transparency. The screens are controlled by the computer 1. The viewing image formed by this system depends upon the displacement of the viewer's eyes to form an auto-stereoscopic three-dimensional image. The only problem that must be solved is the calculation of the images (i.e., calculated images) on the distant and near screens for integrating stereo images in the viewer eyes.

One means to solve this problem is to assume that L and R are a left and right pair of stereo images and a viewing-zone for the viewers eye positions is constant. A spatial mask of an amplitude-type will be assumed for simplicity.

As illustrated in FIG. 5, two light beams will come through the arbitrary cell z 28 on the near screen 18 in order to come through the pupils of eyes 34 and 36. These beams will cross mask 20 and distant screen 22 at the points a(z) 26 and c(z) 30, b(z) 24 and d(z) 32, respectively. The image in the left eye 36 is a summation of:

SL_{z}=N_{z}+M_{a(z)}+D_{b(z)}, (Eq. 1)

where N is the intensity of the pixel on the near screen 18, M is the intensity of the pixel on the mask 20, and D is the intensity of the pixel on the distant screen 22.

For right eye 34, respectively, the summation is:

SR₂=N_{z}+M_{c(z)}+D_{d(z)}, (Eq. 2)

When light is directed through all the pixels z(n) of near screen 18, the images SL and SR are formed on the retinas of the viewer. The aim of the calculation is a optimizing of the calculated images on the near and distant screens 18 and 22 to obtain

SL→L, (Rel. 1)

SR→R. (Rel. 2)

where L and R represent true images of the object.

One can prove that it is impossible to obtain an exact solution for the arbitrary left and right images, L and R. That is why the present invention seeks to find an approximated solution in the possible distributions for N and D to produce a minimum quadratic disparity function (between target and calculated images):

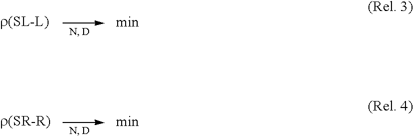

where ρ(x) is a function of the disparity, with the limitation of pixel intensity varying within 0≦N≦255, 0≦D≦255 to for constant M.

An artificial Neural Network (“NN”) can be advantageously used for problem solving in embodiments of the present invention because it allows for parallel processing, and because of the possibility of DSP integrated scheme application.

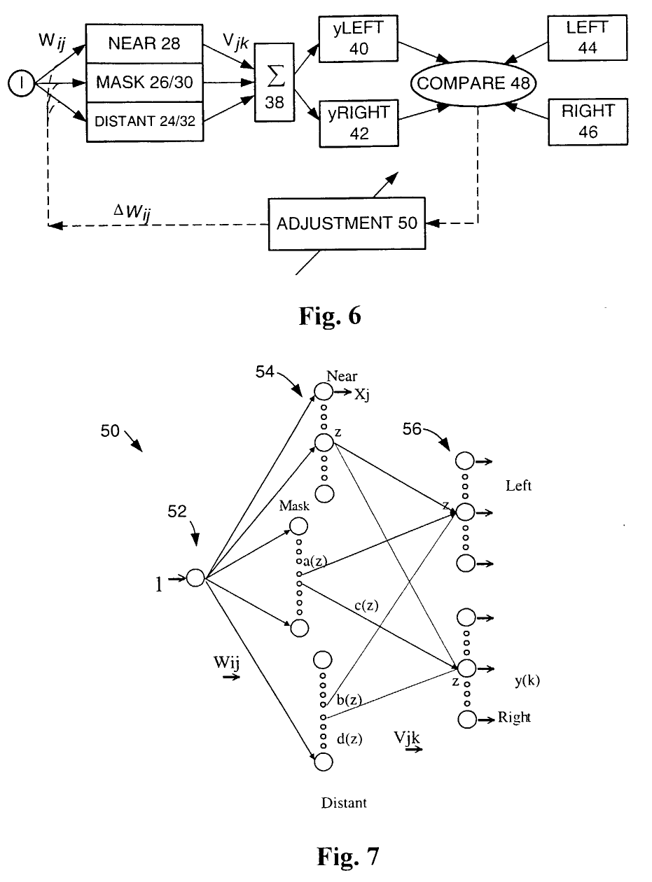

The neural network architecture of FIG. 7 was applied to the present problem. 50 is a three layer NN. The input layer 52 consists of one neuron that spreads the unit excitement to the neurons of the hidden layer 54. The neurons of the hidden layer 54 form three groups that correspond to the near and distant screens and the mask. The neurons of the output layer 56 forms two groups that correspond to images SL and SR. The number of neurons corresponds to the number of liquid crystal display screen pixels. Synaptic weights Wᵢⱼ that corresponds to the near and distant screens is an adjusting parameter, and Wᵢⱼ of the mask is a constant. Synaptic interconnection between hidden layer neurons corresponds to the optical scheme of the system:

$${V}_{j , k =} \{ \begin{matrix}1 \text{-} if j = k \& k , a ( k ) , b ( k ) is on the same line \\ or j = k \& k , c ( z ) , d ( z ) is on the same line \\ \\ 0 \text{-} otherwise\end{matrix} \qquad \text{(Eq. 4)}$$

Nonlinear functions are a sigmoid function in the value [0-255]:

$$F ( x ) = \frac{255}{1 + exp ( - x )} . \qquad \text{(Eq. 5)}$$

The functioning of the NN can be described by:

$$\begin{matrix}{X}_{j} = F ( {\sum }_{j} {W}_{ij} {Inp}_{i} ) = F ( {W}_{1 j} ) = \{ \begin{matrix} {D}_{j} - if j ∈ D \\ {M}_{j} - if j ∈ M - output of hidden layer \\ {N}_{j} - if j ∈ N\end{matrix} & \text{(Eq. 6)} \\ {Y}_{k} = F ( {\sum }_{k} {V}_{i k} {X}_{j} ) - {O}_{N N} & \text{(Eq. 7)}\end{matrix}$$

where O_{NN} is the output of the NN.

The output signal in any neuron is a summation of at least one signal from the distant and near screens and the mask. The output of the NN (according to (6), (7)), corresponding to the left and right eye of the viewer, are given by the following equations:

Yₖ(left)=F(X_{z}+X_{a(z)}+X_{b(z)})=F(N_{z}+M_{a(z)}+D_{b(z)}) (Eq. 8)

Yₖ(right)=F(X_{z}+X_{c(z)}+X_{d(z)})=F(N_{z}+M_{c(z)}+D_{d(z)}) (Eq. 9)

which are derived from equations (1) and (2), above.

The error function then is the summation of all of the errors and can be represented by the following equation:

$$E = {\sum }_{k} ρ ( {Y}_{k} ( left ) - {L}_{k} ) + {\sum }_{k} ρ ( {Y}_{k} ( right ) - {R}_{k} ) \qquad ( Eq . 10 )$$

where E represents the error term.

From (8), it is evident that when E, the error, approaches a zero value (i.e., during NN learning, the output of the hidden layer will correspond to the desired calculated images to be illuminated on the screens.

During NN learning, the weights Wᵢⱼ will initially have random values. These random values are then continuously refined during each iteration of learning by the NN. A back propagation method (BackProp) was used to teach the NN:

$${W}_{ij} ( new ) = {W}_{ij} ( old ) - α \frac{ⅆ E}{ⅆ {W}_{ij}} , \qquad \text{(Eq. 11)}$$

where α is a velocity of the learning. The experiments show that an acceptable accuracy was obtained at 10-15 iterations according (10) learning, for some images the extremely low errors can be achieved in 100 iterations. The calculations show the strong dependence between the level of errors and the parameters of the optical scheme, such as the shape of the images L and R, the distance between the near and distant screens and the mask, and the viewer eye position.

For obtaining more stable solutions for small variations of the optical parameters, two alternative methods can be used.

The first method involves modification of the error function (9), by adding a regularization term:

$$E = {\sum }_{k} ρ ( {Y}_{k} ( left ) - {L}_{k} ) + {\sum }_{k} ρ ( {Y}_{k} ( right ) - {R}_{k} ) + β \frac{{W}_{ij}^{2}}{2} \qquad \text{(Eq. 12)}$$

where β is a regularization parameter.

The second method involves randomly changing the position of the viewer eye by a small amount during the training of the NN. Both of these methods can be used for enlarging of the area of three-dimensional viewing.

Training methods other than “BackProp” can also be used. For example, a conjugated gradients method can be alternatively used wherein the following three equations are employed:

Wᵢⱼ(t)=Wᵢⱼt−1)+α(t)Sᵢⱼ(t−1) (Eq. 13)

$$\begin{matrix}{S}_{i , j} ( t ) = - {G}_{ij} ( t ) + \frac{{‖ {G}_{ij} ( t ) ‖}^{2}}{{‖ {G}_{ij} ( t - 1 ) ‖}^{2}} {S}_{ij} ( t - 1 ) & \text{(Eq. 14)} \\ {G}_{ij} ( t ) = \frac{ⅆ E}{ⅆ {W}_{ij}} & \text{(Eq. 15)}\end{matrix}$$

It should be understood that equations (13)-(15) embody a variant of Fletcher-Reeves, and can accelerate the training procedure of the NN by up to 5-10 times.

A typical system to employ the present invention consists of two 15″ AM liquid crystal displays having a resolution of 1024×768 and a computer system on based on an Intel Pentium III-500 MHz processor for stereo image processing. In such a system, preferably the distance between the panels is approximately 5 mm, and the mask comprises a diffuser. A suitable diffuser type is a Gam fusion number 10-60, made available by Premier Lighting of Van Nuys, Calif., which has approximately a 75% transmission for spot intensity beams as less diffusion may lead to visible moiré patterns. The computer emulates the neural network for obtaining the calculated images that must be illuminated on the near and distant screens in order to obtain separated left-right images in predefined areas. The neural network emulates the optical scheme of display and the viewer's eye position in order to minimize the errors in the stereo image.

The signals corresponding to the transmissivity of the near and distant screens' cells are input into the memory unit by means of the processing block following the set program. The next step is to identify the light signals that can be directed from the cells of all the screens towards the right and left eyes of at least one viewer. Then compare the identified light signals directed towards each eye to the corresponding areas of the set 2-D stereopair image of the relevant object.

For each cell of each screen, the error signal is identified between the identified light signal that can be directed towards the relevant eye and the identified relevant area of the stereo picture of the relevant object aspect that the same eye should see. Each received error signal is compared to the set threshold signal. If the error signal exceeds the set threshold signal, the mentioned program of the processing block control changes the signals corresponding to the screen cells. The above process is repeated until the error signal becomes lower than the set threshold signal or the set time period is up.

It is also possible to solve the calculations for the case of two (or more) different objects reconstructed in two (or more) different directions for two (or more) viewers. It must be mentioned specifically that all calculations can be performed in parallel; the DSP processors can be designed for this purpose.

It should also be noted that the system of the present invention may also be used with multiple viewers observing imagery simultaneously. The system simply recognizes the individual viewers' positions (or sets specific viewing zones) and stages images appropriate for the multiple viewers.

To adapt a system that uses a set image-viewing zone (or zones) so as to allow a viewer to move, a viewer position signal is input into the system. The algorithms used to determine SL and SR use variables for the optical geometry, and the viewer position signal is used to determine those variables. Also, the viewer position signal is used to determine which stereopair to display, based on the optical geometry calculation. Numerous known technologies can be used for generating the viewer position signal, including known head/eye tracking systems employed for virtual reality (“VR”) applications, such as, but not limited to, viewer mounted radio frequency sensors, triangulated infrared and ultrasound systems, and camera-based machine vision using video analysis of image data.

As will be readily appreciated by one skilled in the art, in certain embodiments of the invention, the light source can be a substantially broadband white-light source, such as an incandescent lamp, an induction lamp, a fluorescent lamp, or an arc lamp, among others. In other embodiments, light source could be a set of single-color sources with different colors, such as red, green, and blue. These sources may be light emitting diodes (“LEDs”), laser diodes, or other monochromatic and/or coherent sources.

In embodiments of the invention, the liquid crystal display panels comprise switchable elements. As is known in the art, by adjusting the electric field applied to each of the individual color panel pairs, the system then provides a means for color balancing the light obtained from light source. In another embodiment, each color panel system can be used for sequential color switching. In this embodiment, the panel pairs include red, blue, and green switchable panel pairs. Each set of these panel pairs is activated one at a time in sequence, and display cycles through blue, green, and red components of an image to be displayed. The panel pairs and corresponding light sources are switched synchronously with the image on display at a rate that is fast compared with the integration time of the human eye (less than 100 microseconds). Understandably, it is then possible to use a single pair of monochromatic displays to provide a color three-dimensional image.

While preferred embodiments of the present invention have been shown and described herein, it will be obvious to those skilled in the art such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope by the claims as follows.

What is claimed is:

1) A method for producing a three-dimensional image of an object, said method comprising:
obtaining a phase screen, said phase screen having known information represented thereon;
creating a flat image on a display, said flat image representing an amplitude hologram, said amplitude hologram representing amplitude information calculated from a holographic image of said object and from said known information in said screen; and
projecting said flat image from said display onto said screen such that it combines with said known phase information of said screen to produce a three dimensional image of said object.

2) The method according to claim 1, wherein said known information represented on said phase screen comprises phase information.

3) The method according to claim 2, wherein said phase information of said screen interferes with said amplitude hologram to produce a three-dimensional image of said object.

4) The method according to claim 1, wherein said known information represented on said phase screen comprises mixed phase-amplitude information.

5) The method according to claim 4, wherein said mixed phase-amplitude information of said screen interferes with said amplitude hologram to produce a three-dimensional image of said object.

6) The method according to claim 1, wherein said display is a transmissive liquid crystal display.

7) The method according to claim 1, wherein said amplitude information is iteratively calculated to reduce error in said three dimensional image of said object.

8) The method according to claim 1, wherein said calculated amplitude information is obtained by the steps of:
estimating the light wave components being created by individual pixels of said display when displaying said flat image;
calculating a resulting three dimensional image of an object from the expected interaction of said estimated light wave components and said known information of said screen;
comparing the resulting three dimensional image with a desired three dimensional image to obtain a degree of error; and
adjusting said flat image until said error reaches a predetermined threshold.

9) The method according to claim 8, wherein said steps for calculating said amplitude information is performed using a neural network.

10) A system for producing a three-dimensional image of an object, said system comprising:
a phase screen, said phase screen having known information represented thereon;
a transmissive display capable of displaying two dimensional images
a display control system containing a computational device, said display control system being adapted to control pixels of said transmissive display, and said computational device being adapted to generate a flat image representing an amplitude hologram, said amplitude hologram representing amplitude information, said amplitude information being calculated by said computational device using said known information in said screen so as to create a holographic image of said object when said flat image is projected onto said screen; and
a light source for illuminating said transmissive display so as to project said flat image onto said screen, said light source being controlled by said display control system.

11) The system according to claim 10, wherein said known information represented on said phase screen comprises phase information, and wherein said phase information of said screen interferes with said amplitude hologram to produce a three-dimensional image of said object.

12) The system according to claim 10, wherein said known information represented on said phase screen comprises mixed phase-amplitude information, and wherein said mixed phase-amplitude information of said screen interferes with said amplitude hologram to produce a three-dimensional image of said object.

13) The system according to claim 10, wherein said screen is fabricated of glass having a polymer layer, said screen having a complex surface created in it by laser.

14) The system according to claim 10, wherein said transmissive display is a liquid crystal display.

15) The system according to claim 10, comprising at least three transmissive displays an at least three light sources, each said transmissive display and each said light source being adapted to produce one of three color components of said flat image, said color components of said flat image being combinable to produce a full color three dimensional image of said object.

16) The system according to claim 1, wherein said amplitude information is iteratively calculated in said computational device to reduce error in said three dimensional image of said object.

17) The system according to claim 10, wherein said computational device employs a neural network to reduce error in said three dimensional image of said object.

18) The system according to claim 10, wherein said computational device calculates said amplitude information operating according to the steps of:
estimating the light wave components being created by individual pixels of said transmissive display when displaying said flat image;
calculating a resulting three dimensional image of an object from the expected interaction of said estimated light wave components and said known information of said screen;
comparing the resulting three dimensional image with a desired three dimensional image to obtain a degree of error; and
adjusting said flat image until said error reaches a predetermined threshold.

19) The system according to claim 18, wherein said steps for calculating said amplitude information is performed using a neural network.

20) The system according to claim 10, wherein said display control system further comprises means for sensing a spatial orientation of a viewer of said three dimensional image, and wherein said computational device is adapted to adjust said generated flat image such that said viewer can perceive said three dimensional image of the object.
